(19) United States
(12) Patent Application Publication
(10) Pub. No.: US 2006/0181838 A1
(43) Pub. Date: Aug. 17, 2006

(54) Meter package system

(75) Inventor: Roger Ely, Macon, GA (US)

Correspondence Address: TROUTMAN SANDERS LLP, 600 PEACHTREE STREET , NE, ATLANTA, GA, 30308, US

(73) Assignee: The Southern Company, Atlanta, GA (US)

(21) Appl. No.: 11/345,446

(22) Filed: Feb. 1, 2006

Related U.S. Application Data
(60) Provisional application No. 60/649,014, filed on Feb. 1, 2005.

(51) Int. Cl. H02B 1/26

(52) U.S. Cl. 361/622

(57) ABSTRACT

A utility meter system for metering a building is described. The utility meter system includes a conduit, a meter box assembly and a support mechanism. The conduit can be adapted to house and provide at least one utility cable to the utility meter system. The meter box assembly can be adapted to house at least one connector, the connector in communication with the utility cable from the conduit, wherein the meter box assembly is in communication with the conduit. The support mechanism can provide stability to the meter box assembly, and the support mechanism can include a first end and a second end, wherein the meter box assembly is in communication with the first end of the support mechanism.

### CROSS-REFERENCE TO RELATED APPLICATIONS

This application claims benefit, under 35 U.S.C. §119(e), of U.S. Provisional Application Ser. No. 60/649,014, filed 1 Feb. 2005, the entire contents and substance of which are hereby incorporated by reference.

### BACKGROUND

1. Field of the Invention

The present invention relates generally to a device for providing a building with temporary and/or permanent utility services and, more particularly, to self-supporting metering systems.

2. Description of Related Art

Meter devices are well known in the art. If fact, nearly every utility serviced structure, i.e., a home, office, or building, has a meter connected. A meter device can indicate the amount of utility consumed by the structure, wherein utility companies can charge their customers the appropriate amount that was used over a given time. Upon reading the meter, the amount of utility consumed can be determined. Essentially, the meter is the device for utility companies to charge or bill their customers for the amount of their product (e.g., electricity, telephone, cable, water, and the like) that was used.

Conventionally, meter devices are installed in contact with the structure to be metered for support and stability. For instance, some electrical service meters are mounted on an exterior wall of the structure.

Typically, the unavailability of electrical power is a problem whenever a new building is in the early stages of construction. Electrical power cannot be supplied to the new building until a meter has been installed. Moreover, the meter cannot be installed until the walls of the building are erected, because the meter is conventionally mounted on a wall of the new building. Consequently, much of the construction must be completed without the convenience of an easily accessible power supply. The result is that construction workers must draw their power from other sources; i.e., buildings with power or special temporary installed outlet boxes for construction purposes, which are commonly installed on service poles distant the structure.

This problem is greatly aggravated in newer housing projects and subdivisions wherein underground electrical service has been installed, therefore, eliminating the possibility of providing outlet boxes on service poles. The only source of electric power available to operate construction equipment is neighboring buildings which are completed or in advanced stages of construction and, therefore, have existing electric service.

Since buildings which have electric power are often located at an inconveniently large distance from the construction site, it may be necessary to have many feet of extension cable available. The excessive use of extension cable is not the most desirable solution to the problem for a number of reasons. Power losses over the long lengths of cable may cause damage to power equipment; other construction workers may trip over partially hidden extension cables; cables may be damaged by equipment used on the construction site; the cables are a nuisance to retrieve after each workday; the cables may become muddy and even more difficult to retrieve; and they are expensive.

In an attempt to avoid the use of lengthy and expensive extension cords, power companies can install a temporary power source that is in communication with a meter, sometimes a good distance from the structure. Often, the contractor of the building will request a meter and a temporary power source be installed to alleviate the possibility of potential injuries and excessive costs of using the extension cord solution. After the need of temporary power is complete, the temporary power source must be removed, and a clear path from the temporary meter to the structure provided to run the utility to the structure. And it can be inconvenient to dig a new trench to bring the utility to the structure, both because it requires a new visit by the company and can be costly. A new trench dug upon completion of construction can likely cross previously-laid cable paths, and can further cause damage.

Unfortunately, in the construction of a building supplied by utility underground cables, the process of installing a meter is especially complicated. For instance, a power company must visit the construction site a number of times before the installation of a power meter, employed for measuring power consumption of the building, can be completed.

Initially, the power company will receive a request for installation of a power source, and consequently a meter device, to the building and/or construction site. As a result, the power company will send one or more linemen to dig a trench, in order to lay the proper cable to the building. Sometimes the trench may include cables from other utilities, e.g., cable, television, telephone, and the like. When the linemen arrive at the construction site, there can be obstructions due to other contractors working at the site that may hinder the ability to dig a trench on that visit. Until the obstructions have been removed, the linemen may need to revisit the site which causes additional costly linemen visits. Hence, the power company is expending significant costs in an attempt to provide the building with power, as the power company must continue to send their linemen to visit the construction site until the linemen have access to dig the trench and lay the necessary cable from the temporary site to the final site of the meter.

Meter devices that have tried to solve some of the problems described are typified in U.S. Pat. No. 3,025,432 to Giegerich, U.S. Pat. No. 3,796,822 to Eickman, U.S. Pat. No. 3,879,641 to Byrd, U.S. Pat. No. 3,906,686 to Dillon, U.S. Pat. No. 4,864,467 to Byrd et al., U.S. Pat. No. 5,638,256 to Leach et al., and U.S. Pat. No. 6,393,775 to Staschik. Yet, none of these disclose a meter service package that is capable of providing temporary service for construction of a building, and permanent service when the building is complete. Each reference includes disadvantages and limitations overcome by the present invention.

In particular, U.S. Pat. No. 3,879,641 refers to a utility meter pedestal-foundation mounting patent. Byrd discloses a utility meter pedestal for mounting a utility meter on the foundation of a building prior to the construction of the walls of a building. Byrd requires permanent attachment, and needs the support of the foundation of the building.

U.S. Pat. No. 4,864,467 publicly discloses a utility meter pedestal. This invention provides for a utility meter mounting pedestal used in underground utility service, after a foundation has been constructed, yet before a building has been erected. The support must be adapted to be mounted on a building foundation.

U.S. Pat. No. 5,638,256 discloses a service meter entrance device for temporary and permanent use. The Leach et al. device must be attached to wall or other vertical surface. Thus, it requires the support of the foundation of a building.

Indeed, FIGS. 1 and 2 depict conventional, prior art meter pedestals that must be supported by a wall of a building. Referring to FIG. 1, a meter pedestal 100 is illustrated. The utility meter pedestal 100 is mounted onto a wall 105 of a building 110 for stability and can provide an entryway for utility cables to enter the building 110. The meter pedestal 100 includes a meter box 115, a conduit 120, and at least one utility cable 125. The meter box 115 is a conventional type and is adapted to receive a plug-in meter 130. The conduit 120 houses and protects the utility cables 125 that are supplied to the building 110. FIG. 2 illustrates the same meter pedestal 100, but provides a front view.

Therefore, it can be seen that a need exists for a self-supporting meter system that can be installed without the support of a building, such that the same initially-placed meter can serve, in essence, as both a temporary meter (before and during construction of the structure), and the permanent meter (upon final construction). It is the provision of such a meter system that the invention is primarily directed.

### SUMMARY

A utility meter system for metering a structure is described. The single meter system can be used to deliver a utility during and after construction of the structure, or building. Indeed, the utility meter system can comprise a meter box assembly adapted to house at least one connector, the connector being in communication with a utility communication line; a support mechanism providing free-standing stability to the meter box assembly without support from the structure, the support mechanism having a first end and a second end, wherein the meter box assembly is at the first end of the support mechanism; and a conduit adapted to house at least one utility communication line in communication with the meter box assembly.

The support mechanism can further comprise a footer device to aid in stability, the footer device at the second end of the support mechanism, and being preferably positioned underground.

The meter box assembly can include a utility compartment and a customer compartment. The meter box assembly a barrier separating the utility compartment from customer compartment so that the utility compartment is isolated from the customer compartment. The meter box assembly can further comprise a meter device to measure an amount of a utility through the utility communication line used by the structure over time. Moreover, the meter system can further comprise a communication device adapted to transmit data related to utility usage to a remote location.

The customer compartment can include a safety device for protection of the meter system. The utility communication line can provide to the utility meter system provides the structure a utility selected from the group consisting of electrical, telecommunication, entertainment, water and antenna.

The meter box assembly can include also a temporary power connector enabling the use of the utility meter apparatus for temporary power, and a permanent power connector enabling the use of the utility meter apparatus for permanent power, wherein the temporary power connector is positioned exterior to the meter box assembly.

The meter box assembly can include a door connected by a hinge to the customer compartment of the meter box assembly.

The support mechanism can be placed, preferably, with a range of six inches to ten inches of the structure.

The meter system can comprise a meter box assembly having an interior; an isolation barrier positioned within the interior of the meter box assembly; a utility compartment within the interior of the meter box assembly having a utility meter device; a customer compartment within the interior of the meter box assembly being separated by the utility compartment by the isolation barrier; at least one utility cable coupled to the meter box assembly providing a utility to the meter system and the structure; and a connector in communication with the utility cable enabling access to the utility. In addition, the meter system can further comprise a communication device adapted to transmit data obtained from the meter system related to utility usage to the utility.

In one embodiment, the meter system can be positioned underground in a waterproof housing. In another embodiment, the meter system can be positioned above the ground atop a free-standing support mechanism and distant a building.

In a meter system having a meter box assembly connected to a building for support and stability, a meter device for measuring utilities coupled to the meter box assembly, a utility compartment of the meter box assembly including the meter device, a customer compartment of the meter box assembly, a barrier to separate the utility compartment from the customer compartment, the improvement comprising removing the meter box assembly from the building and positioning the meter box assembly on a free-standing support mechanism distant the building.

The improved meter system, wherein the meter box assembly is positioned upon a support mechanism distant the building with a range of six inches to ten inches. Also, the meter box assembly of the improved meter system can be positioned underground in a weatherproof housing.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 depicts a cross sectional side view of a conventional meter pedestal attached to a wall of a building for support and stability.

FIG. 2 depicts a front view of the conventional meter pedestal attached to the wall of the building for support and stability.

FIG. 3 depicts a perspective view of a meter package system, in accordance with a preferred embodiment of the present invention.

FIG. 4 depicts a perspective view of another meter package system before the erection of a wall of the building for which the meter package system can meter utilities, in accordance with a preferred embodiment of the present invention.

FIG. 5 depicts a perspective of the meter package system before the erection of the wall of the building, in accordance with a preferred embodiment of the present invention.

FIG. 6 depicts a front perspective view of the meter package system after the erection of the wall of the building, in accordance with a preferred embodiment of the present invention.

FIG. 7 depicts a side perspective view of the meter package system after the erection of the wall of the building, in accordance with a preferred embodiment of the present invention.

FIG. 8 depicts an environment of a partial cross sectional view of a meter package system positioned underground, in accordance with another preferred embodiment of the present invention.

FIG. 9 depicts connections to the underground meter package system, in accordance with a preferred embodiment of the present invention.

FIG. 10 depicts a perspective view of the underground meter package system, in accordance with a preferred embodiment of the present invention.

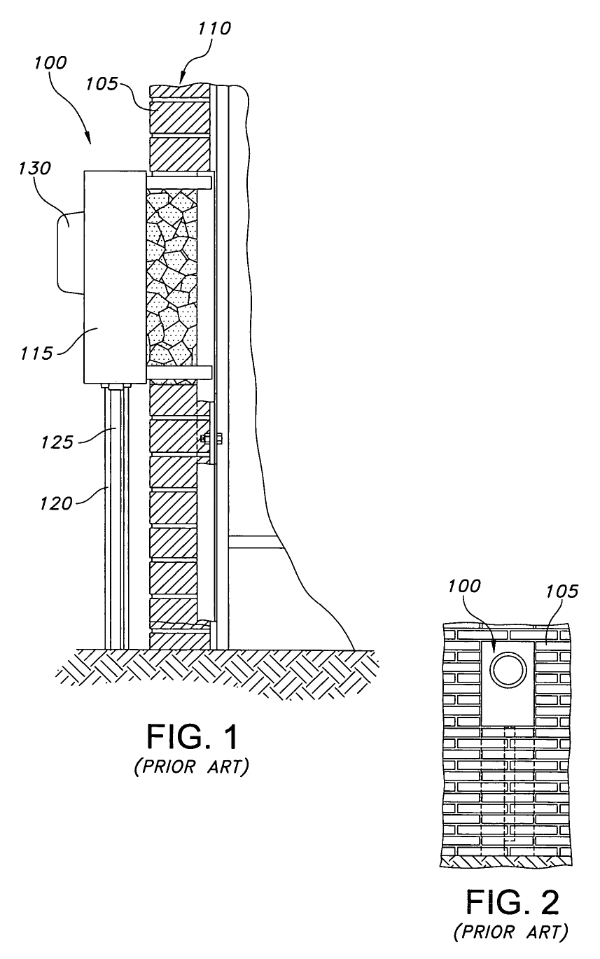

### DETAILED DESCRIPTION

To facilitate an understanding of the principles and features of the invention, it is explained hereinafter with reference to its implementation in an illustrative embodiment. In particular, the invention is described in the context of meter system for metering and monitoring one or more utilities.

Referring now in detail to the drawing figures, wherein like reference numerals represent like parts throughout the several views, the present invention comprises a meter system.

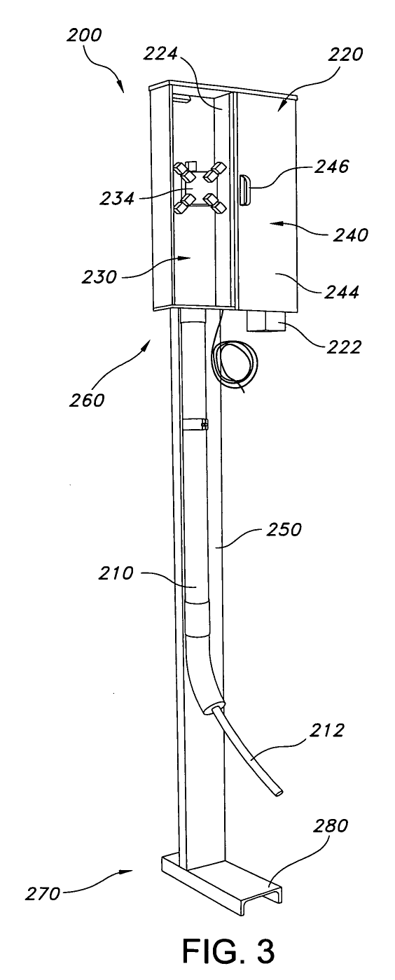

FIG. 3 depicts a perspective view of a meter system or a meter package system 200, in accordance with a preferred embodiment of the present invention. The meter system 200 includes a conduit 210, a meter box assembly 220, and a support mechanism 250. The conduit 210 can be adapted to house and provide at least one utility delivery system 212 (for example, with electricity, a cable 212) from a utility service line to the meter box assembly 220. The meter box assembly 220 can be adapted to house at least one connector 234. The connector 234 can be in communication with the utility cable 212 from the conduit 210, wherein the meter box assembly 220 is in communication with the conduit 210. The support mechanism 250 can provide stability to the meter system 200, enabling the meter system to be positioned distant a building. The support mechanism 230 can have a first end 260 and a second end 270. The 220 is in communication with the first end 260 of the support mechanism 270.

The meter system 200 is, preferably, a self-supporting meter pedestal. Unlike conventional meter pedestals that require the stability and support of structure, such as a wall of a building, the present invention meter system 200 can be positioned at a construction site prior to walls and the like being built; that is, not having to rely on the finished building for support or safety. For cables that are to be placed underground, the new and improved meter system 200 enables utility companies to dig a trench before obstructions are placed upon the property of the new building. The result is a cost savings for the utility company, as the company need not repeatedly send linemen to dig the trench and lay utility cable. Instead, only one visit by the linemen is required. Additionally, since the meter system 200 can be outfitted with temporary connectors, such as power outlet connectors, the contractors are spared to the task of creatively providing temporary power for the construction site that differs in location and/or type from the eventual permanent meter.

Generally, buildings have a meter. The meter is the device by which utility companies monitor and charge customers for the amount of utilities used. For instance, an electric power company has a watt-hour type meter on the building to determine the amount of kilowatt-hours that were used by the building. The meter can display the amount of utility used in a given timeframe therein allowing the power company to charge or bill their customers an appropriate amount.

The conduit 210 of the meter system 200 can be the device by which a cable 212 can be safely fed into the meter box assembly 220. The conduit 210 is, preferably, an elongated cylinder having a hollow core, wherein the hollow core is sufficiently large enough to receive and hold at least one utility cable 212.

In a preferred embodiment, the conduit 210 can be made of cast iron or other weatherproof, non-rusting metals. In an alternative embodiment, the conduit 210 can be made of a PVC pipe (polymer of vinyl chloride). The conduit 210 can also be constructed from other polymer materials, such as polyolefins, such as, but not limited to ultra-high molecular weight (UHMW) polyethylenes, low, medium, and high density polyethylenes, polyurethanes, polyamides, and copolymers, and combinations thereof. In addition, other materials, including metals such as aluminum, titanium, and the like, metal alloys, ceramics, and the like, can be used for the conduit 210, without departing from the scope of the invention. The material selected for the conduit 210 is, preferably, weatherproof and sufficiently large enough to house one or more utility communication line 212.

The communication line 212 housed by the conduit 210 can be a cable from a utility company. For instance, the cable 212 can be a power cable (e.g., conductor) from a power utility to provide electrical power to the building. The cable 212 can also be a number of cables for different companies. For instance, the cable 212 can include cables from a power utility, a telecommunications utility, a cable utility, a fiber utility, an entertainment utility, as well as combinations of different utilities (i.e., a telecommunications cable and a power cable through the same conduit), and the like.

The meter box assembly 220 of the meter system 200 can provide a service entrance into a building. In addition, the meter box assembly 220 can be a combination service entrance, wherein having at least two compartments and a barrier to mechanically separate the compartments.

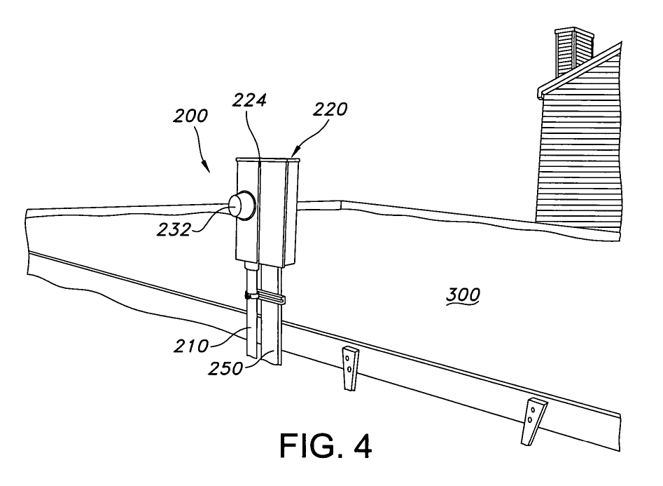

Preferably, the meter box assembly 220 includes two compartments—a utility compartment 230 and a customer compartment 240. The compartments 230 and 240 are mechanically separated by a barrier 224, wherein a customer does not have access to the utility compartment 230. The utility compartment 230 can include a housing for a meter device 232 (shown in FIG. 4). Referring still to FIG. 3, the utility compartment 230 can include a connector 234, which can preferably receive the plug-in meter device 232. One skilled in the art would appreciate that more than two compartments on the meter box assembly 220 can be provided (e.g., the utility compartment can include more than one utility to be metered, and/or the customer compartment can include more than one customer—for example, in an apartment building or multi-family dwelling environment).

Preferably, the utility compartment 230 can be secured by the utility company, wherein a customer or potential vandal cannot access the compartment 230. Indeed, the utility compartment 230 is preferably locked.

The customer compartment 240 can include a safety device 242. The safety device 242, e.g., a circuit breaker, can protect the building and meter box assembly 220 should an overflow of electrical power occur. The safety device 242 can be coupled to the cable 212 to detect a change in characteristics of the meter box assembly 220.

The customer compartment 240 can be sealed with a door 244; the door 244 can be hinged. The door 244 can be accessible by a customer or utility linemen. The inner portion of the customer compartment 240, in an exemplary embodiment, is accessed by pulling on a handle 246 of the door 244.

Preferably, in proximity to the customer compartment 240 is a connector 222. The connector 222 can be a conventional power outlet, a ground fault circuit interrupter (GFCI) connector, a telecommunications coaxial or fiber cable, a telephone connector, and the like. Thus, preferably, the connector 222 allows a customer to connect to the meter system 200 directly. For example, the customer may want to provide holiday lights outside the house. Instead of threading an extension cord from inside the building, the connector 222 can be a power outlet to provide the necessary electricity to power the holiday lights. Indeed, the connector 222 can act initially as a temporary power source, but can remain exterior to the meter assembly 220 for future customer use.

The support mechanism or channel 250 supports the meter system 200. The support mechanism 250 has a first end 260 and a second end 270. Preferably, the first end is in communication with the meter box assembly 220. The second end 270 is in communication with a support device 280. Indeed, in a preferred embodiment, the support device 280 is a footer that enables added stability to the support mechanism 250.

The support mechanism 250 is partially buried into the ground in proximity to a location that will eventually include a wall of the structure where the meter will seamlessly attach. The support mechanism 250 can be in the range of approximately two feet in height to approximately nine feet in height. Preferably, the support mechanism 250 is made of cast iron galvanized metal. In addition, the support mechanism 250 can be composed wood, brick, and/or of polymer materials, such as polyolefins, such as, but not limited to ultra-high molecular weight (UHMW) polyethylenes, low, medium, and high density polyethylenes, polyurethanes, polyamides, and copolymers, and combinations thereof. In addition, other materials, including metals such as aluminum, titanium, and the like, metal alloys, ceramics, and the like, can be used for the support mechanism 250, without departing from the scope of the invention. The material selected for the support mechanism 250 is, preferably, weatherproof and capable of supporting the meter box assembly 250. Indeed, the support mechanism 250 can support the meter box assembly 240 in different environments—hot, cold, humid, wet, dry, and the like.

The support device, or footer, 280 can be made of similar material as the support mechanism 250. The footer 280 can be connected to the support mechanism 250 by bolting, welding, nailing, and the like. The length of the footer 280 can be in the range of six inches to five feet, depending on the height of the support mechanism 250. As one skilled in the art would appreciate, the length of the footer 280 can be dependent on the height of the support mechanism 250. The footer 280 can provide the lateral stability of the support mechanism 250, and should be formed like all components of the present invention, to withstand corrosion in its environment.

Referring now to FIG. 4, the meter system 200 can be placed in proximity to the situs of the building to be metered. The building can be a new building in construction, planted near a foundation 300. Alternately, the building can be an existing structure, wherein the conventional, building-attached meter pedestal 100 is being replaced with the present invention.

As FIG. 4 illustrates, the conduit 210 and support mechanism 250 are buried a predetermined depth into the earth. In a preferred embodiment, the support mechanism 250 can be placed adjacent to the conduit 210 (side by side). In an alternative embodiment, the conduit 210 can be the support mechanism 250, wherein the conduit both supports the meter box assembly 220 and houses the cable 212. In yet another alternative embodiment, the conduit 210 can be placed in front of or behind the support mechanism 250, wherein the conduit can be seen or hidden from view, respectively, from viewing a front of the meter system 200 from the meter device.

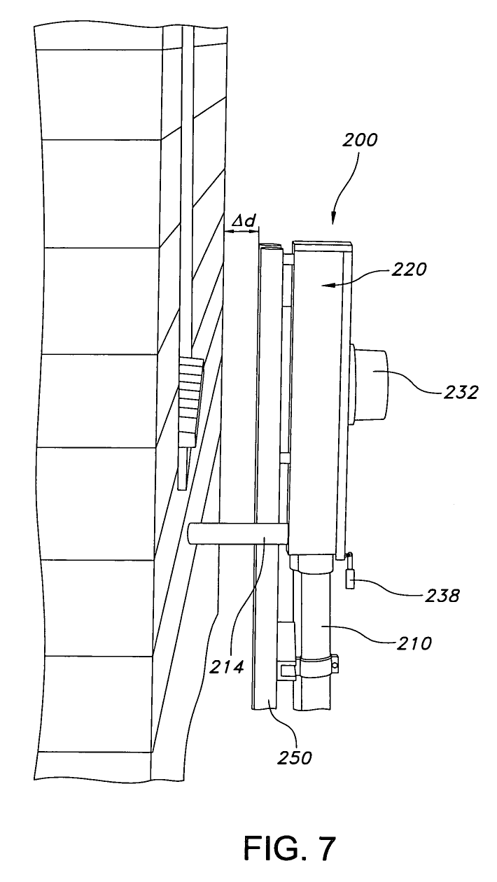

Although shown in FIG. 7, the present invention can further include an entry conduit 214. The entry conduit 214 can enter the structure to be metered and provide the necessary cabling to the building. The entry conduit 214 can extend laterally from the meter box assembly 220, or can extend into the ground and enter the building at an underground location.

While the meter system 200 is described as being planted into the ground, one skilled in the art would appreciate that the meter system can be posted or planted into a concrete structure in an underground room of the building, such as a basement.

FIG. 4 depicts the meter system 200 with the meter 232 attached. The meter 232 is positioned on the utility compartment side 230 of the meter box assembly 220. Often, the cover of the meter 232 extends laterally from the meter box assembly 220, as depicted in FIG. 4. The meter 232 is the device that can display the amount of utility consumed by the building over a predetermined or certain duration. For instance, the meter 232 can be a digital display that can indicate the amount of kilowatt-hours of electrical power used by the building. The meter 232 can also be an analog display, wherein a wheel on the power meter revolves; the amount of revolutions of the wheel can be tallied by a dial reading, wherein the dial reading depicts the amount of utility consumed.

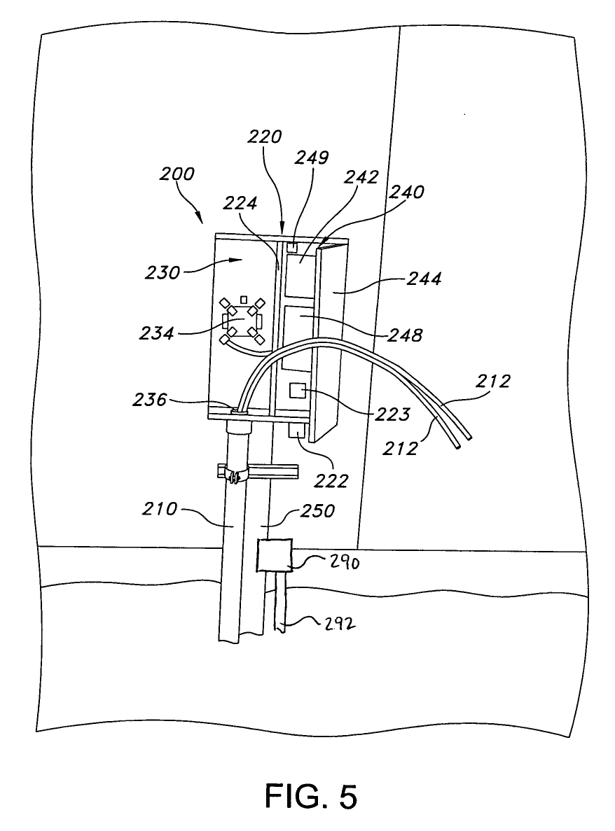

Referring to FIG. 5, the meter package system 200 is depicted. The meter box assembly 220 is open, and the inner characteristics of the meter box assembly 220 are displayed. The utility compartment 230 includes the meter connection 234 to receive the plug-in meter 232. An aperture 236 can be located at a bottom of the meter box assembly 220, preferably on the utility compartment 230 side of the meter box assembly 220. The conduit 210 carrying the cable 212 is in communication with the aperture 236. The cable 212 coming from the utility company enters the conduit 210, and the cable 212 is protected from the environment of the meter system 200 by the conduit 210. The cable 212 is fed from the conduit 210 to the meter box assembly 220 via the aperture 236. At least a portion of the cable 212 is in communication with the meter connection 234, for utility metering purposes.

The customer compartment 240 of the meter box assembly 220 is also shown in FIG. 5. A safety device 242 can be included on the customer compartment 240. The safety device 242 can be a circuit breaker to protect the building and/or the meter system 200. For instance, the circuit breaker can switch when a high-voltage spike comes across the meter system 200. The following is a list, not to be exhaustive but only illustrative, of potential devices 223 that can be included in the customer compartment 240: additional metering devices, safety devices, switches, additional connectors for power, cables, and the like, communication devices, and antennas. One skilled in the art would appreciate still that other devices can be included in the customer compartment 240 for use of additional utility companies and the consumer.

An additional meter device 290 can be included with the present invention. For instance, the meter device 290 can be secured to the support mechanism 250 by conventional securing devices and means. The meter device 290 can meter one or more utilities meter devices, such as: cable, fiber, telephone, and the like. The meter device 290 can receive the utility cables to be metered via the conduit 292. The conduit 292, like conduit 210, is sufficiently large enough to house the utility cables to be metered.

As utility companies increase their desire to reduce the expense of meter readers labor, the implementation of communication devices from the meters becomes necessary. Accordingly, the present invention can include a communication device 249. The communication device 249 can include transmitter, a receiver, and/or a transceiver, wherein the communication device 249 can enable transmitting and receiving data to/from the meter system 200. For instance, at a predetermined time the utility company can ping the communication device 249 requesting the meters to be read. The communication device 249 of the meter system 200 can be programmed to transmit a reading to the utility company. The meter system 200 can also communicate the meter readings via the communication device 249 reducing the need of expensive, human meter readers to wander through neighborhoods or office parks to read meters.

While the inner compartment of the customer compartment 240 can include connectors, the exterior of the customer compartment 240 can also include at least one connector 248. Indeed, the connector 248 can be a weatherproof power outlet, enabling temporary power when construction requires a power outlet and permanent power when a customer needs additional power. The connector 248 can be a coaxial connector, a fiber optic connector, an antenna connector, a telecommunications connector, and the like. Preferably, the connector 248 is weatherproof (such as ground fault circuit interrupter) as it must be able to withstand the environment of the meter system.

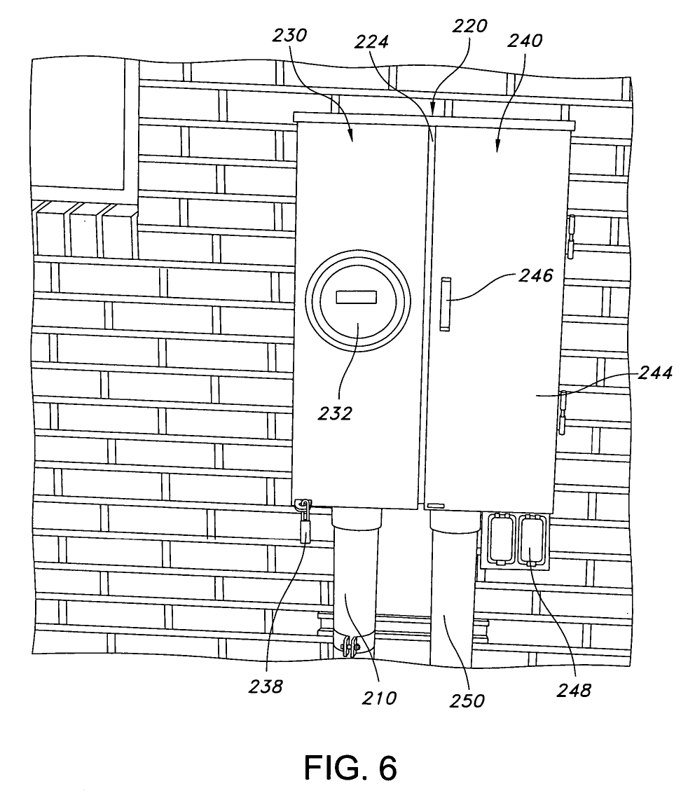

Referring to FIG. 6, the meter system 200 is illustrated in front of a building to be metered by the meter system 200. A locking mechanism 238 can be used to secure the utility compartment 230 of the meter box assembly 220. Indeed, though not illustrated, the customer compartment 240 can also be secured with a locking mechanism. The locking mechanism 238 for the customer compartment can, in an exemplary embodiment, be placed in proximity to the handle 246. The locking mechanism 238 can be a key lock, a combination lock, and the like. One skilled in the art would appreciate that the locking mechanism 238 can include many conventional locking features, wherein keeping unwanted persons from having access to the meter box assembly 220.

Referring now to FIG. 7, the present invention is illustrated as being positioned distant the building. The meter package system 200 is at least a distance Ad from the building. The distance Ad can be in the range of four inches to three feet. The preferred distance of the meter system 200 from the building, for aesthetic reasons, is rather close to the building, and in the range of six inches to ten inches. It has been found that a Ad greater than ten inches can become a safety hazard and an obstacle for existing building owners. One skilled in the art would appreciate that the meter system 200 can be placed farther than three feet from the building, wherein the cables 212 exiting the meter system 212 can enter the building underneath the ground, rather than through a laterally extending entry conduit 214 into a wall of the metered building.

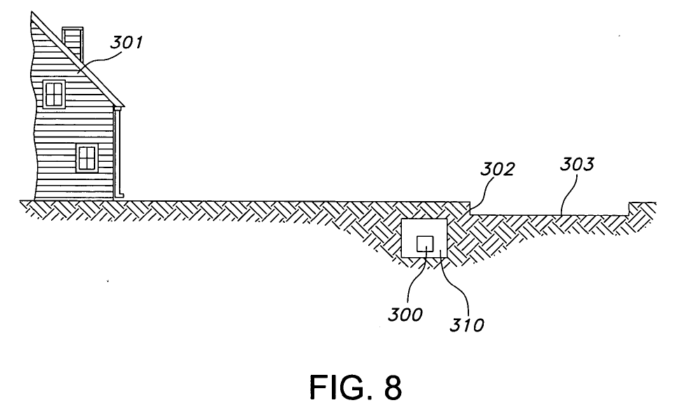

In another preferred embodiment, the present invention can be placed underground, as illustrated in FIG. 8. A meter package system 300 can be placed underneath the ground distant the building to be metered. FIG. 8 illustrates an exemplary distant, underground meter can be placed distant a building 301. Indeed, FIG. 8 illustrates the meter system 300 being near the curb 302 of a road 303. Preferably, the meter system 300 is placed in a weatherproof housing 310 to protect the underground meter system 300 from water, frost, and the like. For instance, the weatherproof housing 310 can be made of molded plastic, rubber, and the like. The housing 310 can include a door to provide access into the housing 310, wherein enabling metering of the system 300. The door can be removable or hinged to the housing 310.

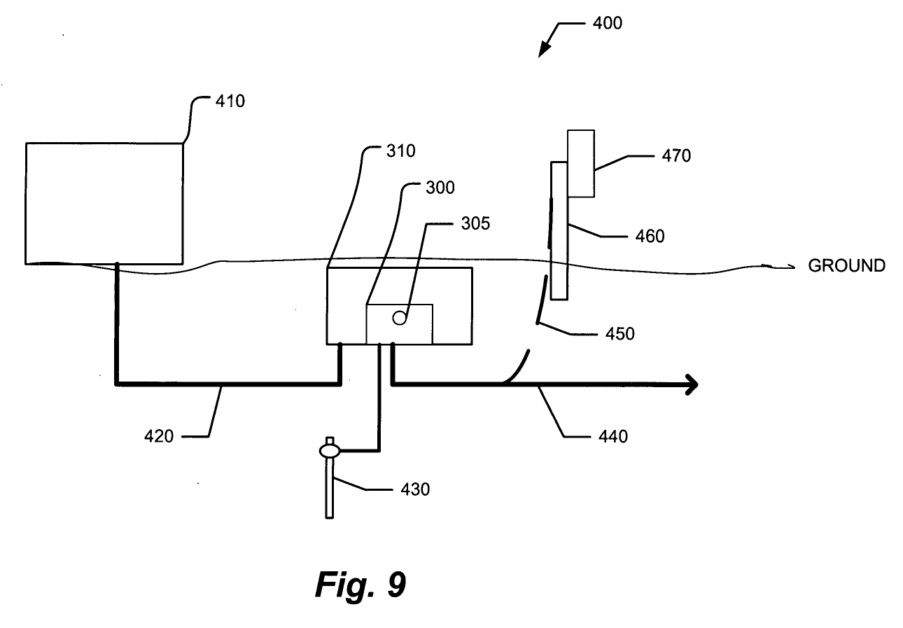

FIG. 9 illustrates the operation system 400 of the underground meter package 300. A utility transformer 410, preferably, exists above the ground. The transformer 410 can shift the voltage and/or current of the utility up or down, based on the need. Preferably, the transformer 410 takes distribution power and transforms the power down to a desired and predetermined power level. The power is then transferred underground via a utility service conductor 420 to the underground meter system 300. The conductor 420 is fed to the underground meter system 300. The meter package system 300 rests safely in the housing 310. A grounding rod 430 can be in communication with the meter system 300. The grounding rod 430 protects the meter system 300 from lightning, line surges, or unintentional contact with higher voltage lines; the grounding rod 430 provides an alternative path of the electrical system to protect the meter system 300. A service conductor 440 is fed from the meter system 300 and is connected to the metered building (as illustrated with an arrow on the conductor). The meter system 300 includes a meter device 305 to meter and indicate the amount of utility consumed by the building.

If a temporary power setting is desired, a temporary panel conductor 450 can be in communication with the service conductor 440 that is being fed to the building. The temporary panel conductor 450 can attach to a support apparatus 460 enabling an above-ground temporary panel 470. The temporary panel 470 can provide the necessary utilities needed via connectors, e.g., power outlets, and the like, above ground while construction is being completed. Preferably, after the building construction is complete, the temporary panel 470 is removed from the construction site and the underground meter system 300 is the only meter device for the building. For instance, the temporary panel 470 enables the availability of electrical power for use by contractors in construction of the building.

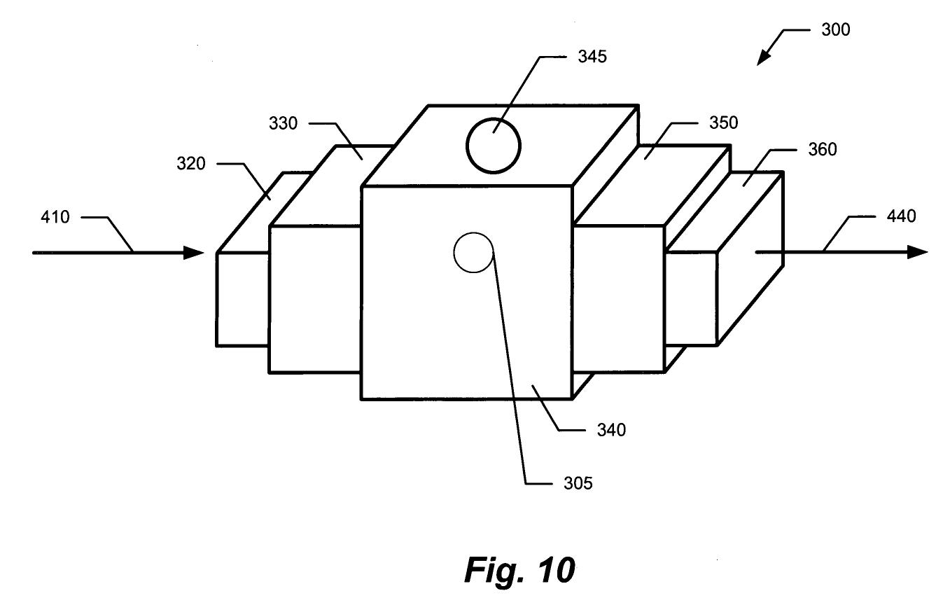

Referring to FIG. 10, the meter package system 300 is illustrated. The conductor 410 fed from a transformer enters the meter system 300. The conductor 410 enters a locking disconnect 320. The locking disconnect 320 can be, essentially, a switch to open and/or close the meter system 300 from the utility side. A utility termination point 330 is in communication with the locking disconnect. The utility termination point 330 is the place where the utility side ends. The utility termination point 330 is in communication with a meter base 340 of the meter system 300. The meter base 340 includes a meter and can display the amount of utility consumed by the building being metered. For instance, the meter base 340 can display the amount of electrical power consumed by the building. The meter base 340 can include a view port 345. The view port 345 can be accessible on a top of the meter base 340. One can read the meter by viewing through the view port 345. In an exemplary embodiment, the view port 345 can be a removable device, wherein the reader can read the meter by removing the view port 345. After the meter base 340, a customer termination 350 point exists. The customer termination point 350 in communication with a locking disconnect and breaker 360. Thereafter, the conductor 440 is fed from the meter system to the building.

The utility transformer point 330 can exist for many service wire and communications, such as telecommunications, power, and the like, and can further enable remote reading of the meter system 300. The interior of the meter base 340 can include current and potential transformers, computer sampling equipment, communications equipment and the like.

While the invention has been disclosed in its preferred forms, it will be apparent to those skilled in the art that many modifications, additions, and deletions can be made therein without departing from the spirit and scope of the invention and its equivalents, as set forth in the following claims.

What is claimed is:

1. A utility meter system for metering a structure, wherein the same meter system can be used to deliver a utility during and after construction of the structure, the utility meter system comprising:
a meter box assembly adapted to house at least one connector, the connector in communication with a utility communication line;
a support mechanism providing free-standing stability to the meter box assembly without support from the structure, the support mechanism having a first end and a second end, wherein the meter box assembly at the first end of the support mechanism; and
a conduit adapted to house at least one utility communication line in communication with the meter box assembly.

2. The system of claim 1, the support mechanism further comprising a footer device to aid in stability, the footer device at the second end of the support mechanism, and being positioned underground.

3. The system of claim 1, wherein the meter box assembly includes a utility compartment and a customer compartment, a barrier separating the utility compartment from customer compartment so that the utility compartment is isolated from the customer compartment.

4. The system of claim 1, wherein the meter box assembly further comprises a meter device to measure an amount of a utility through the utility communication line used by the structure over time.

5. The system of claim 4, wherein the meter system further comprises a communication device adapted to transmit data related to utility usage to a remote location.

6. The system of claim 3, wherein the customer compartment includes a safety device for protection of the meter system.

7. The system of claim 1, wherein the utility communication line provided to the utility meter system provides the structure a utility selected from the group consisting of electrical, telecommunication, entertainment, and water.

8. The system of claim 7, wherein the meter box assembly includes a temporary power connector enabling the use of the utility meter apparatus for temporary power, and a permanent power connector enabling the use of the utility meter apparatus for permanent power, wherein the temporary power connector is positioned on the exterior of the meter box assembly.

9. The system of claim 7, wherein the meter box assembly includes a lockable door connected by a hinge to the customer compartment of the meter box assembly.

10. The system of claim 1, wherein the support mechanism is placed with a range of six inches to ten inches of the structure.

11. A meter system adapted to measure utilities of a structure, the meter system comprising:
a meter box assembly having an interior;
an isolation barrier positioned within the interior of the meter box assembly;
a utility compartment within the interior of the meter box assembly having a utility meter device;
a customer compartment within the interior of the meter box assembly being separated by the utility compartment by the isolation barrier;
at least one utility cable coupled to the meter box assembly providing a utility to the meter system and the structure; and
a connector in communication with the utility cable enabling access to the utility.

12. The meter system of claim 11, further comprising a communication device adapted to transmit data obtained from the meter system related to utility usage to the utility.

13. The meter system of claim 12, wherein the meter system is positioned underground in a waterproof housing.

14. The meter system of claim 12, wherein the meter system is positioned above the ground atop a free-standing support mechanism and distant a building.

15. In a meter system having a meter box assembly connected to a building for support and stability, a meter device for measuring utilities coupled to the meter box assembly, a utility compartment of the meter box assembly including the meter device, a customer compartment of the meter box assembly, a barrier to separate the utility compartment from the customer compartment, the improvement comprising removing the meter box assembly from the building and positioning the meter box assembly on a free-standing support mechanism distant the building.

16. The improved meter system of claim 15, wherein the meter box assembly is positioned upon a support mechanism distant the building with a range of six inches to ten inches.

17. The improved meter system of claim 15, wherein the meter box assembly is positioned underground in a weatherproof housing.
